(19) United States
(12) Patent Application Publication
(10) Pub. No.: US 2026/0368186 A1
(43) Pub. Date: Nov. 19, 2026

(54) CONTEXTUAL TASK EXECUTION

(71) Applicant: MICROSOFT TECHNOLOGY LICENSING, LLC, Redmond, WA (US)

(72) Inventors: Sakshi MUNJAL, Hyderabad (IN); . CHAITANYA, Karnataka (IN); Priyank RASTOGI, Karnataka (IN); Sachin SWAMI, Sri Ganganagar (IN); Rohan GYANI, Hyderabad (IN); Sheetal S SETHI, Hyderabad (IN); Sandeep Kumar SRIVASTAVA, Hyderabad (IN)

(21) Appl. No.: 19/245,245

(22) Filed: Jun. 20, 2025

(30) Foreign Application Priority Data
May 16, 2025 (IN) 202511047417

(51) Int. Cl. G06F 16/2457; G06F 40/289; G06F 40/40

(52) U.S. Cl. CPC G06F 16/24578; G06F 40/289; G06F 40/40

(57) ABSTRACT

Data is output as grounding artifacts and ranked based on context and user requirements. Techniques for improved preprocessing and reasoning with re-ranking are provided. Depending on the signals from initial phases, the processing pipeline is expanded to perform preprocessing over extracted grounding context and splitting data into chunks with context as needed. Contexts are ranked and irrelevant contexts are filtered out. Additionally, a re-ranking and filtering phase are added. Remaining contexts are synthesized into a usable format. Furthermore, the ability to manage large amounts of grounding context is improved by building an index of all extracted grounding information. Execution agents are configured to read relevant parts of the grounding context during their turn. A further improvement to the grounding adapters is through cache grounding.

### PRIORITY

This application claims the benefit of the foreign filed application in India, Indian application number 202511047417 filed on May 16, 2025, entitled CONTEXTUAL TASK EXECUTION” the entirety of which is hereby incorporated by reference herein.

### BACKGROUND

Many collaboration and planning systems are leveraging artificial intelligence (AI) to generate and execute tasks. To enhance task execution, an infrastructure can be implemented to build, manage, and deploy AI agents, which can include multi-agent deployments where different agents can collaborate to achieve various tasks. Such a system is the Multi-Agent Runtime Service by Microsoft Corporation. The Multi-Agent Runtime Service includes a module to ground data from diverse sources, including meeting recordings, chats, files, shared site files, web content, and planner data with dependencies. However, grounding across these multiple surfaces introduces latency and increases the risk of using incorrect or irrelevant data.

It is with respect to these and other considerations that the disclosure made herein is presented.

### SUMMARY

The present disclosure describes grounding adapters that seamlessly connect with various enterprise data sources and retrieve grounding data. The retrieved grounding data is then processed through a pipeline consisting of a processor, a reasoning agent, and a synthesizer agent. Unlike conventional Retrieval-Augmented Generation (RAG) methods, which primarily retrieves relevant content, the disclosed approach expands upon such methods by reasoning over the retrieved data, ranking the data based on relevance, and synthesizing a refined output. This process ensures that each task has access to the most accurate, contextually appropriate, and actionable insights, thus providing a more advanced and reliable improvement to RAG. The present disclosure describes a multiple phase approach that includes relevance gathering and synthesizing information which can include a ranking of different sources, providing an improved and intelligent grounding solution.

The present disclosure further provides enhancements and improvements to the grounding adapters. In an embodiment, techniques for improved preprocessing and reasoning with re-ranking are provided. Depending on the signals from initial phases, the processing pipeline is expanded to perform preprocessing over extracted grounding context and splitting data into chunks with context as needed. Contexts are ranked and irrelevant contexts are filtered out. Additionally, a re-ranking and filtering phase are added. Remaining contexts are synthesized into a usable format.

The present disclosure further describes enhancements and improvements to the grounding adapters through improved synthesis with indexing. The ability to manage large amounts of grounding context is improved by building an index of all extracted grounding information. Execution agents are configured to read relevant parts of the grounding context during their turn.

The present disclosure further describes enhancements and improvements to the grounding adapters through cache grounding. This includes persisting selected parts of the grounding data for a selected time window to improve performance across multiple task executions. Grounding data to be persisted can include summary type responses from a meta grounding agent, final ranked and filtered grounding contexts, and the final synthesized response.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is an example system in accordance with embodiments of the present disclosure.

FIGS. 2A and 2B is an example system in accordance with embodiments of the present disclosure.

FIG. 3 is an example system in accordance with embodiments of the present disclosure

FIGS. 4A, 4B, and 4C is an example system in accordance with embodiments of the present disclosure.

FIG. 5 is an example system in accordance with embodiments of the present disclosure.

FIGS. 6A, 6B, 6C, 6D, and 6E are example systems in accordance with embodiments of the present disclosure.

FIGS. 7A, 7B, 7C, and 7D are flow diagrams showing aspects of an example routine components in accordance with embodiments of the present disclosure.

FIG. 8 is a diagram showing an illustrative computer hardware and software architecture implementing aspects of the techniques and technologies presented herein.

FIG. 9 is a diagram illustrating a computer hardware and software architecture implementing aspects of the techniques and technologies presented herein.

FIG. 10 is a diagram illustrating a computer hardware and software architecture implementing aspects of the techniques and technologies presented herein.

### DETAILED DESCRIPTION

In systems that provide AI-based services, grounding data is often used to provide an AI model with relevant and context-specific information from a knowledge base to help the AI model generate accurate, contextually appropriate, and domain-specific outputs. The grounding data can be various types of content such as documents and structured records. As the number of grounding sources grow, so will the context that needs to be maintained. This context is likely to grow to exceed the maximum context limit supported by most large language models (LLMs). Thus, there is a need for systems and methods to more accurately select portions of the extracted grounding data relevant for each step which is performed by agents performing various tasks. The grounding data must be selected while making progress on the task at hand. Otherwise, the grounding data may be summarized but at the risk of losing important details. Additionally, different grounding sources offer varying levels of importance depending on the task.

Among various challenges, some examples include:
prioritizing sources: determining which sources are most relevant for each task.
resolving conflicts: combining and de-duplicating information when sources contradict each other.

The present disclosure provides techniques for optimizing queries and ranking multiple grounding sources. In one embodiment, a two staged process is described:
Stage 1: Pull potentially relevant information from all relevant grounding sources (this stage is configured for speed and optimized for recall)
Stage 2: Rank and refine results based on context and user need (this stage is configured to reason more deeply over information extracted in stage 1 and optimize precision).

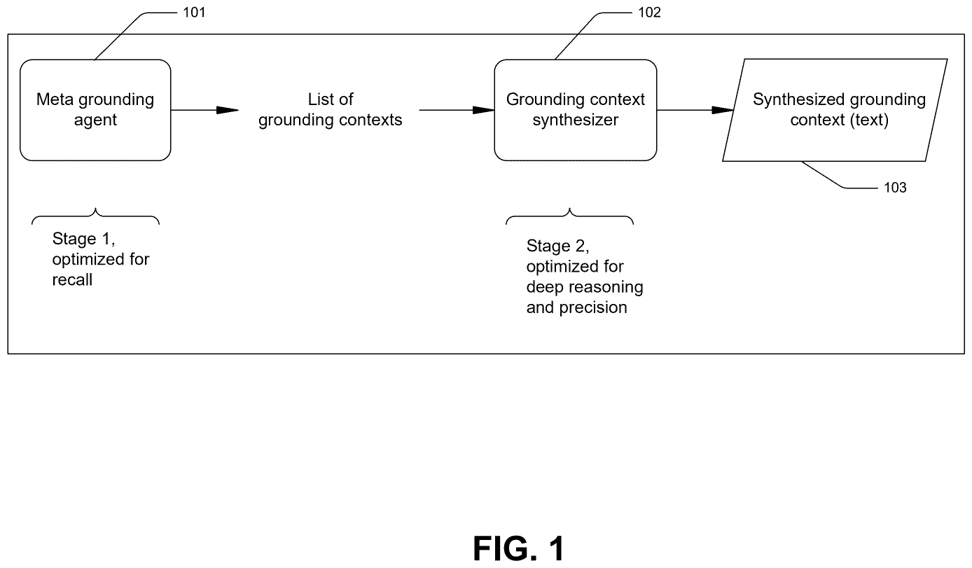

With reference to FIG. 1, in an embodiment, Stage 1 is provided by a meta grounding agent 101 and is optimized for recall, generating a list of grounding contexts. Stage 2 is provided by a grounding context synthesizer 102 and is optimized for deep reasoning and precision. The result is synthesized grounding context 103.

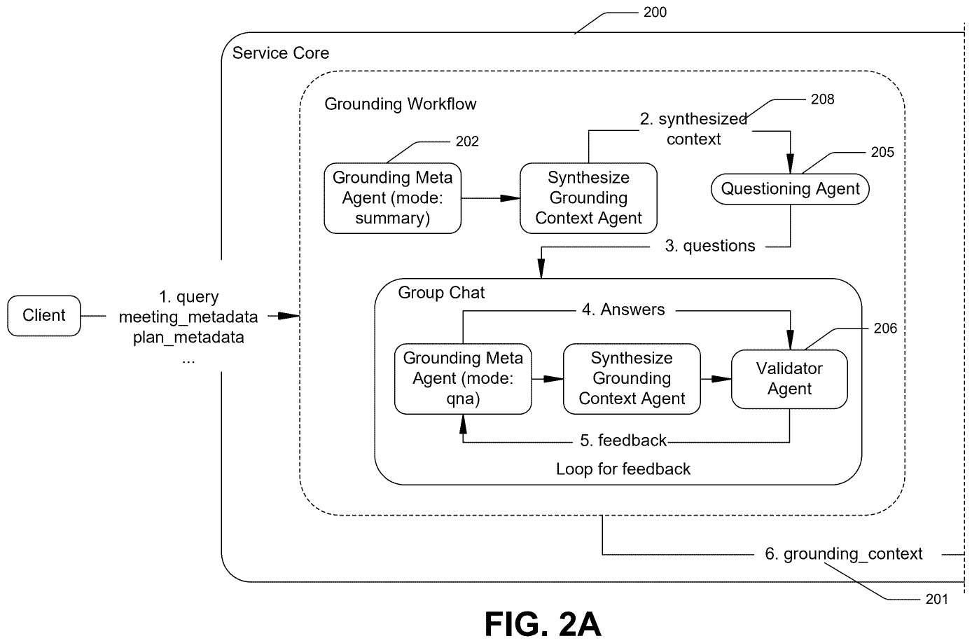

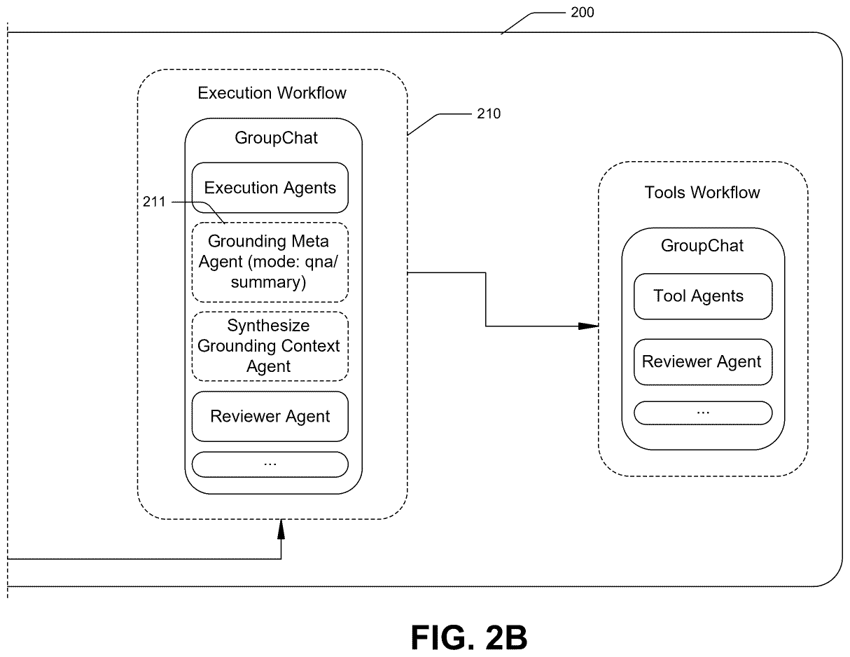

FIGS. 2A and 2B illustrate an example meta grounding architecture 200. The first stage of the grounding process focuses on retrieving any potentially relevant artifacts for grounding. This stage includes multiple modules/plugins that are each configured for querying a different grounding source. The task to be executed, along with task metadata, are used as input for each module in this stage. Each module outputs a list of grounding artifacts of the form {grounding_context, context_metadata}. In an embodiment, the grounding context 201 can be a blob of text with information usable for grounding. The context metadata contains description pertaining to what the blob represents, where it was extracted from, and in what context the information was shared. This metadata is used to rank artifacts from multiple sources and filter relevant artifacts with higher precision in stage 2.

Stage 2 includes synthesis and is configured to provide deeper reasoning over context extracted from individual plugins, including:
1. Ranking-Rank all available artifacts as per their relative importance and relevance to the task at hand. Less relevant artifacts can be dropped in case the input set at this stage is too large.
2. Reasoning-Identify dependencies, overlaps, and information conflicts.
3. Re-ranking and Filtering-Filter out artifacts that do not connect with other relevant artifacts and are also below the minimum relevance threshold.

An agentic workflow is implemented for some or all of the above steps. After completion of stage 2, to synthesize the final grounding context, the disclosed techniques include:
Constructing a grounding context as a text blob that can be passed to the pool of agents working on a task.
Updating the index built at the end of stage 1 and allowing agents to leverage tool calling semantics to read relevant grounding artifacts on-demand.
Preprocessing: Perform preprocessing over extracted grounding context where we split grounding context into chunks with context.

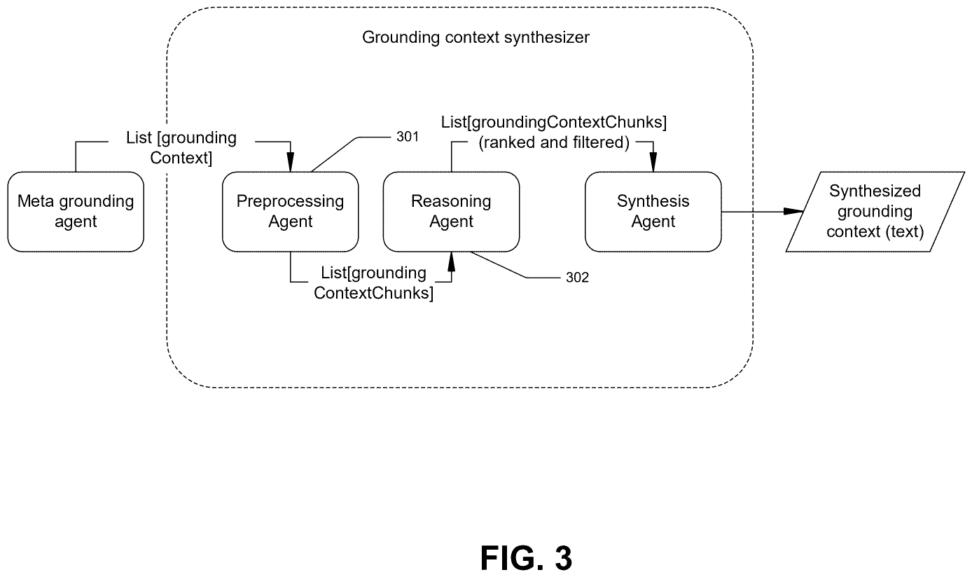

With reference to FIG. 3, in phase 1, an LLM agent (preprocessor_agent) 301 is allowed to split long contexts into smaller chunks. The preprocessor agent 301 is allowed to determine an appropriate chunk size for the given input, and is not required to split the input into paragraphs, sentences, or phrases. Along with splitting into chunks, the preprocessor agent 301 also generates context information indicating what the chunk contains and context from the original source. The LLM agent also generates topic tags that identify the general topics and themes covered by the chunk.

The output of the preprocessing stage is a list of JSON objects with the following format:

{

| | |
|---|---|
| content: string, | // content of the chunk in full, |
| context: string, | // context around what the chunk is, why it might have been added to |

the document and what we could use it for

| | |
|---|---|
| topics: List[string], | // List of Topics covered in this chunk |
| source_name: string, | // name of the original source of this information (web, enterprise |

document, meeting, etc.)

| | |
|---|---|
| source_citation: string, | // link to the source artifact, which we can add in outputs as citations / |

References
}

A reasoning agent 302 is configured to consume the preprocessed contexts, cluster the preprocessed contexts per topic, and for each cluster, perform ranking and filtering in one call, and assess which grounding contexts are less relevant and drop the less relevant contexts. The primary criteria used for ranking is the task relevancy and source credibility. This also results in dropping any duplicates and conflicts.

For synthesis, the reasoning agent 302 collects the results together into one cohesive grounding context string that can then be used by downstream agents to perform assigned tasks. In one embodiment, execution agents can be allowed to parse context chunks on their own.

Referring back to FIGS. 2A and 2B, illustrated is one implementation that includes a grounding meta-agent 202. Grounding meta-agent 202 fetches grounding context from all grounding sources concurrently, synthesizes all the contexts, and provides a synthesized grounding context 208. The grounding meta-agent 202 is configured to support summarization and Q&A modes. In summarization mode, the prompts for grounding agents are tailored for summarization and in Q&A mode, the prompts are specific to obtain the answers. In an embodiment, the grounding context is fetched in summary mode. This summarized context is then passed to a questioning agent 205 along with task details. The questioning agent 205 generates the questions that need to be answered based on the task to be performed and context. The questions are answered using the grounding meta-agent 202 in Q&A mode.

Once the validator agent 206 terminates, the synthesized grounding context (summarized and Q&As) are passed to an execution workflow 210. A grounding meta-agent 211 participates during the execution workflow and assists with any additional context needed during execution. The grounding meta-agent 211 supports both summarization and Q&A modes, and any of the modes can be used during the execution workflow 210.

The grounding meta-agent 211 invokes other concurrent grounding agents, obtains their context, and synthesizes the contexts. The granular grounding agents can be artifact-based or scenario-based.

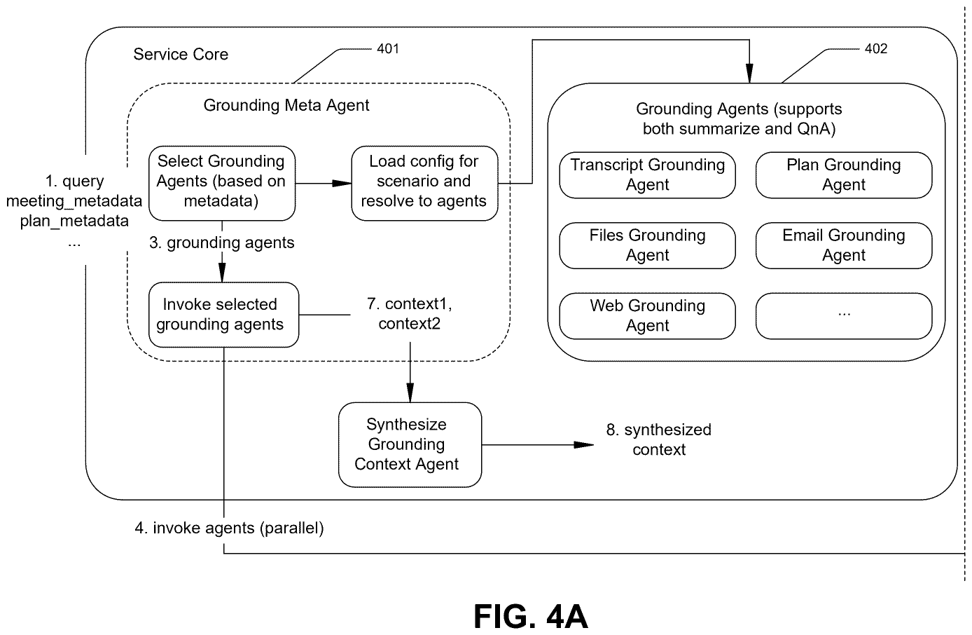

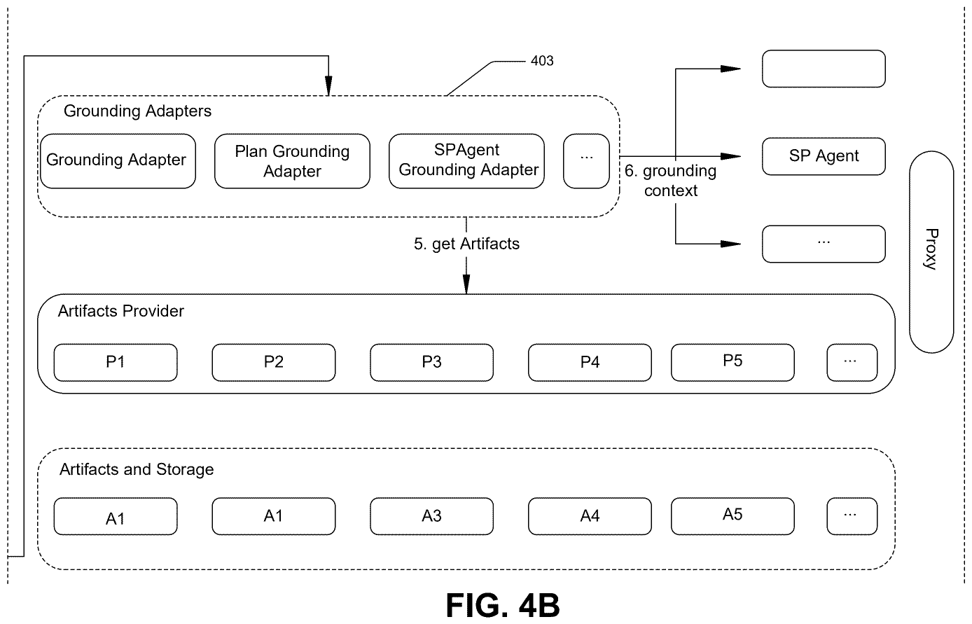

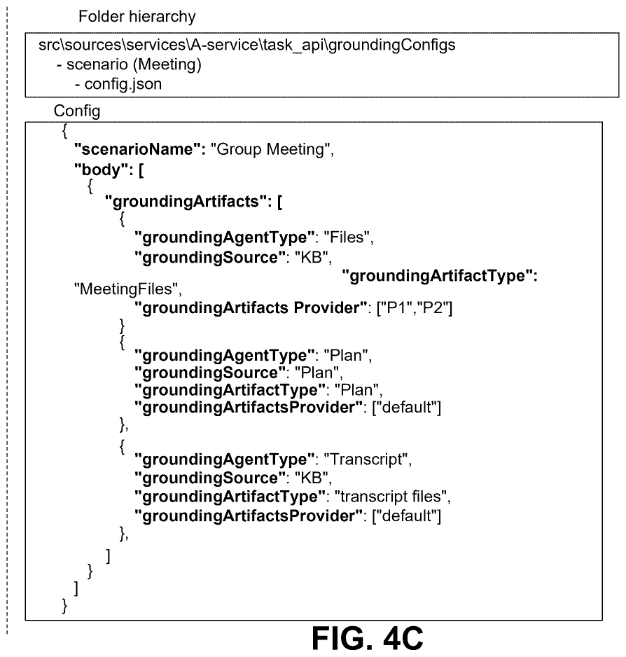

In the example shown in FIGS. 4A, 4B, and 4C, a pool of grounding meta agents 401 and grounding agents 402 can be created for artifacts or for the scenario. These grounding agents 402 invoke the adapters on the proxy side, and the grounding adapters 403 fetch the artifacts such as file links, etc., and obtain the grounding context. The selection of grounding agents is defined by the configuration for the scenario.

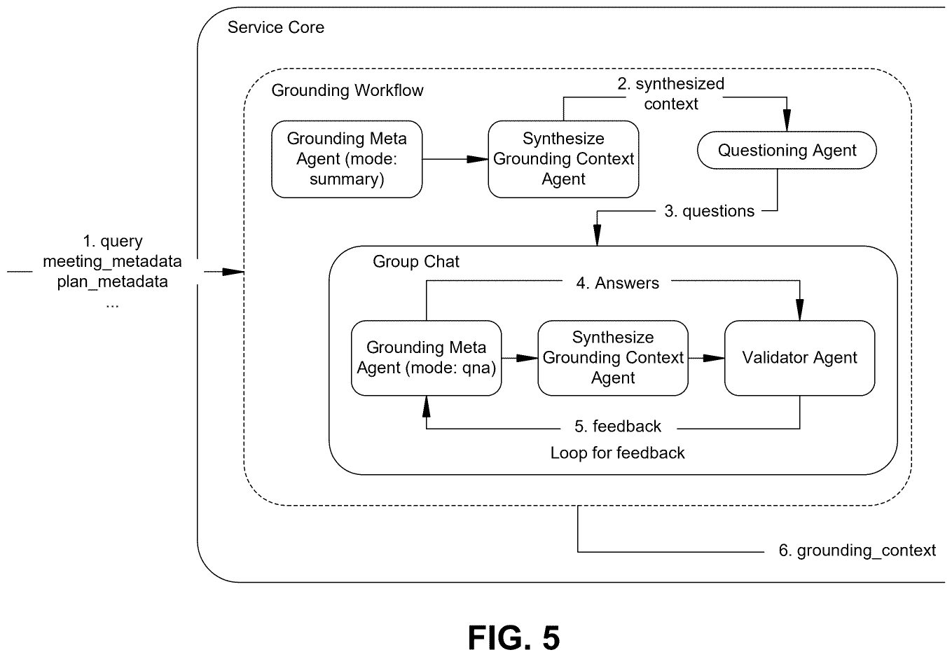

Referring to FIG. 5, an example flow comprises:
1. Define configuration for the scenario
2. Load and resolve configuration to the grounding agents
3. Invoke Adapters and pass configuration metadata
4. Adapter fetches artifacts and obtains grounding context
5. Synthesizer synthesizes multiple grounding contexts

Configuration for the scenario can be defined as an in-memory dictionary or a JSON file based configuration.

In the configuration, the artifact type, grounding agent, and artifacts provider are defined. In an example, a grounding agent type field is bound to the agent and used to resolve to the agent. The complete configuration is passed to the adapter to resolve to appropriate adapter and artifacts provider for the agent. The grounding agent type field is passed to grounding agents once the agents are initialized.

After the resolved grounding agent classes are instantiated, their appropriate grounding adapters are called. The correct grounding adapter is instantiated based on the grounding source using a grounding source attribute from the configuration. The grounding adapter classes fetch the artifacts from an artifacts provider which is a wrapper over services providing artifacts for different scenarios.

After the artifacts are fetched, the adapter class calls grounding sources to fetch the grounding context and return the grounding context to agents. Each adapter class has a mapping of scenario and plugins to be used for different artifacts.

The context is returned along with context metadata to assist in ranking the contexts for the synthesizer.

```
{
grounding_context: string, // context extracted from the grounding source
    context_metadata: {
source_name: string, //
source_citation: [string], // citations or references
context_type: string, // Summary, Q&A
artifact_type: string, // Files, Web, Transcript etc
  }
}
```

In an embodiment, logic for fetching grounding context resides on a proxy layer. The proxy layer includes adapters and artifact providers. The adapters are configured to fetch the grounding context from the grounding source and determine which providers to use for fetching artifacts.

Each grounding agent resolves to a grounding adapter class on the proxy side which handle the grounding request from the agent. The grounding adapter class:
1. Fetches the relevant artifacts using the artifacts provider. The configuration is passed to the adapters to select the appropriate artifacts provider for grounding.
2. Fetches the grounding context from the grounding source

Artifacts providers are wrapped over various services which fetches the artifacts from the services, such as fetching file links for plan grounding and fetching meeting transcripts and files for meeting grounding agents.

A core layer contains AI specific logic and houses the grounding workflow and execution workflow. The grounding workflow uses the proxy layer to obtain the grounding context for various sources from various providers.

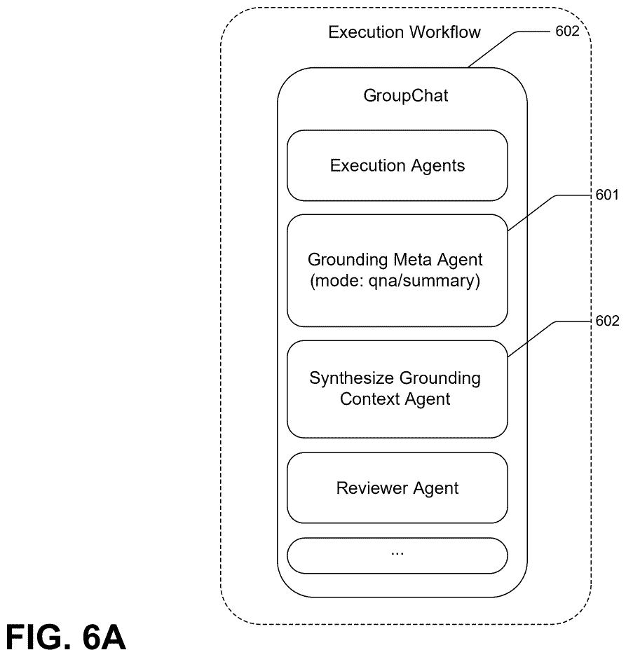

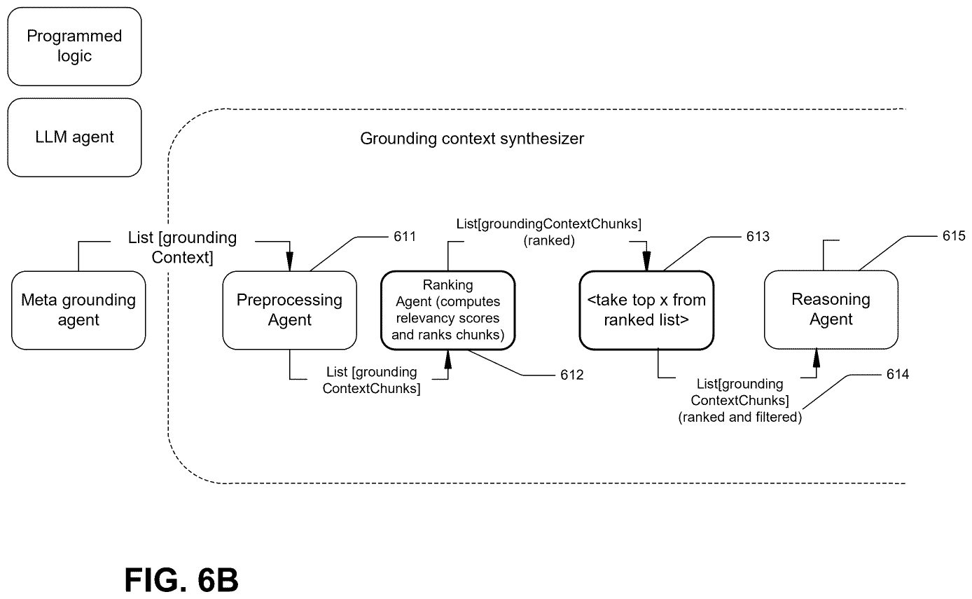

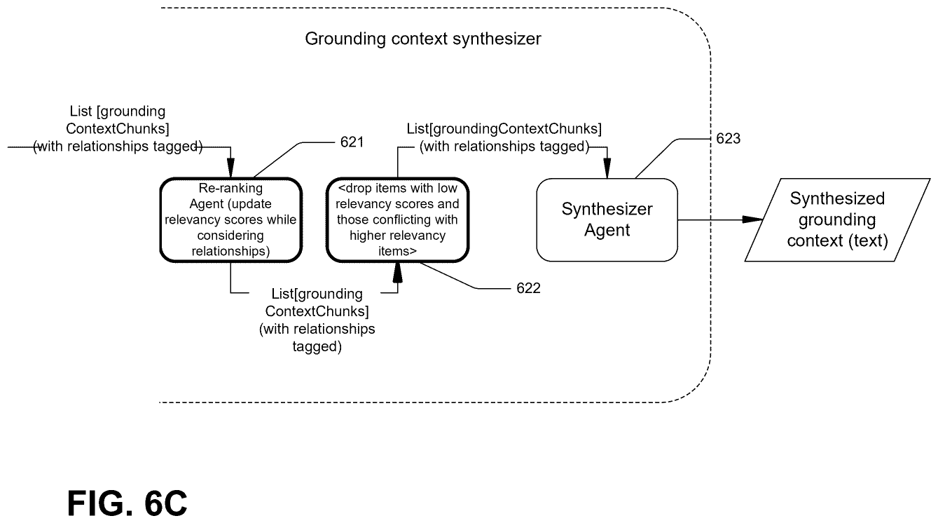

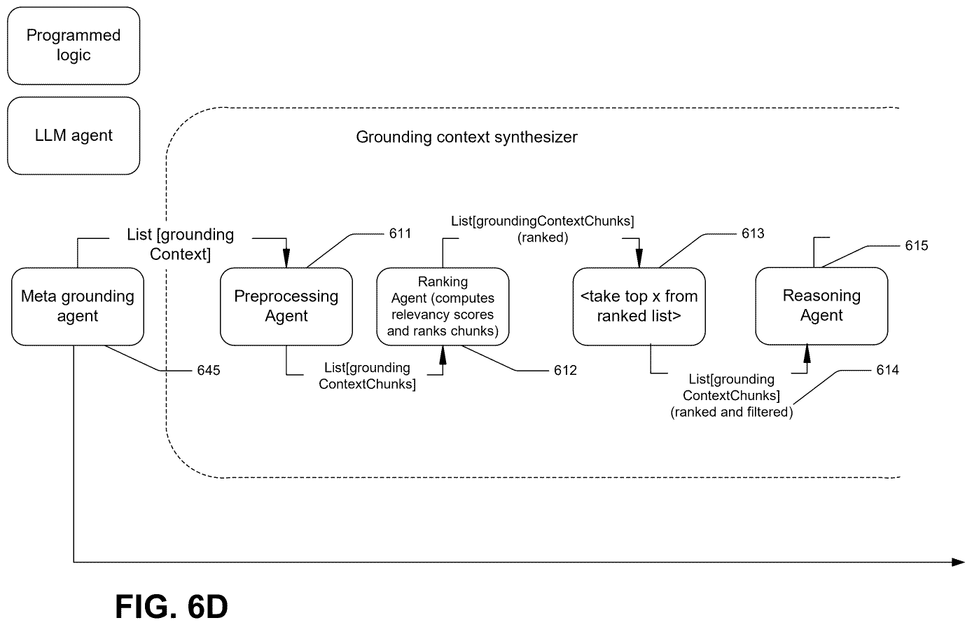

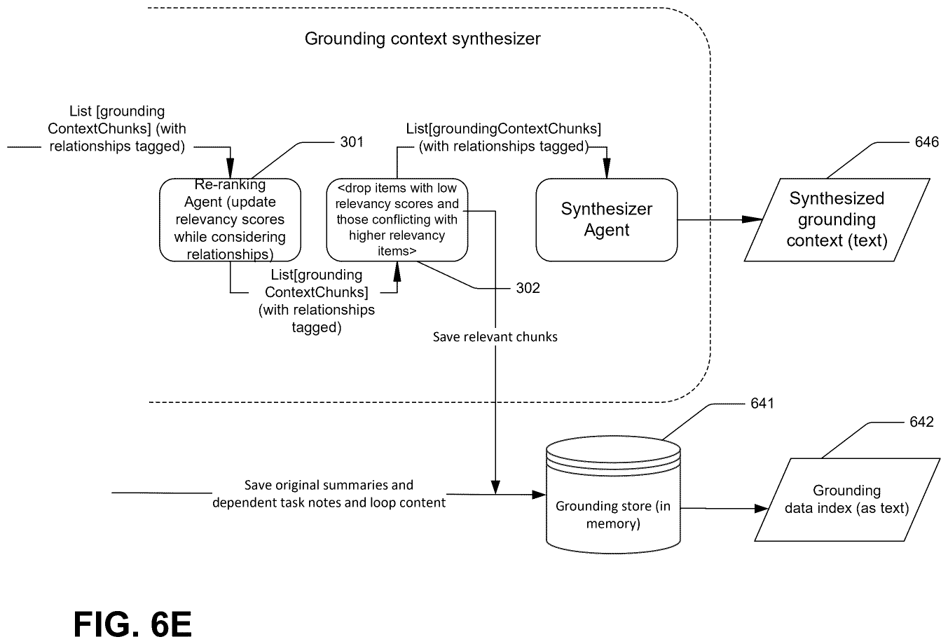

Referring to FIG. 6A, the grounding workflow has a grounding meta agent 601 that is configured to provide synthesized grounding context for a scenario. There will are two phases in the grounding workflow:
1. Fetching the summarized grounding context via the meta grounding agent 601. Here the grounding agents run in summarization mode.
2. The summarized context is passed to a questioning agent along with task metadata, and generates questions to obtain missing information needed to complete the task.

Grounding meta agent 601 is configured to obtain the answers for the questions. The grounding meta agent participates in a group chat 602 with a validator agent. The validator agent validates the answers and provides feedback on unanswered questions. The grounding meta agent 601 runs in Q&A mode. The initial summarized context and Q&A context is synthesized, and passed to further workflows.

Referring to FIG. 6A, the synthesize module 602 operates on the summaries and answers extracted by the meta grounding agent flow and performs the following:
Rank extracted content on the basis of the scenario and the content itself
If needed, drop any extracted content that has a low relevancy
Reason over the remaining content, and extract facts, claims, preferences, etc., expressed in the grounding content.
Perform re-ranking of extracted facts
Synthesize the re-ranked facts into one cohesive context blob that all agents can use. This synthesized context contains:
   A detailed summary of highly relevant grounding facts
   An index detailing all the grounding artifacts extracted so far for any downstream agents to query and use

The grounding agents are used during execution workflow as well. This assists in answering additional unknowns which may arise during execution of tasks. Some approaches through which the grounding meta agent participates in the execution workflow include:
1. The task completion reviewer agent generates questions if it has feedback for the task
2. Additional generated questions are that are needed to answer during execution to a new agent are extracted. This agent receives feedback generated by reviewers and includes the task, context, etc.

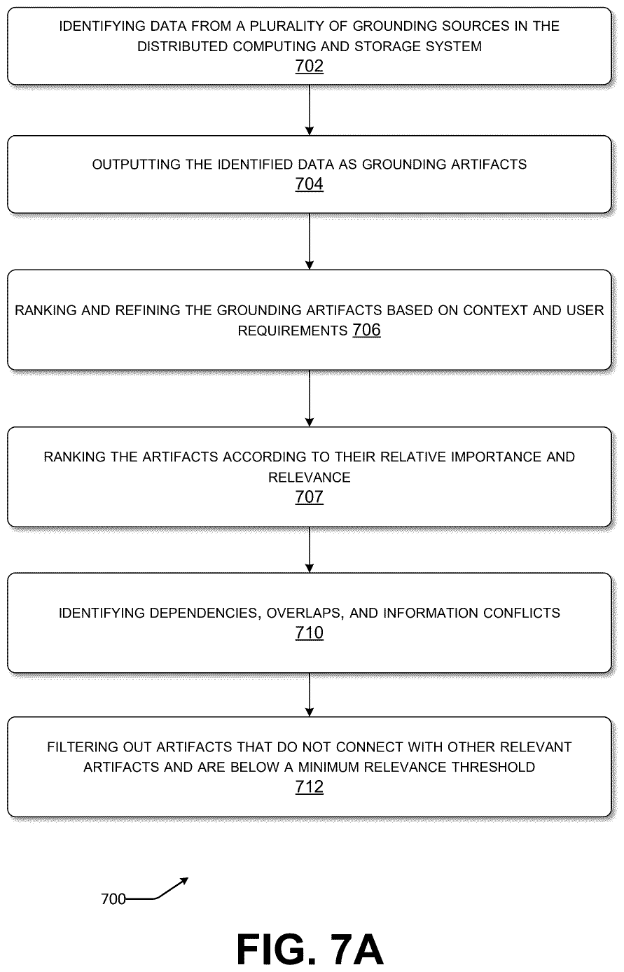

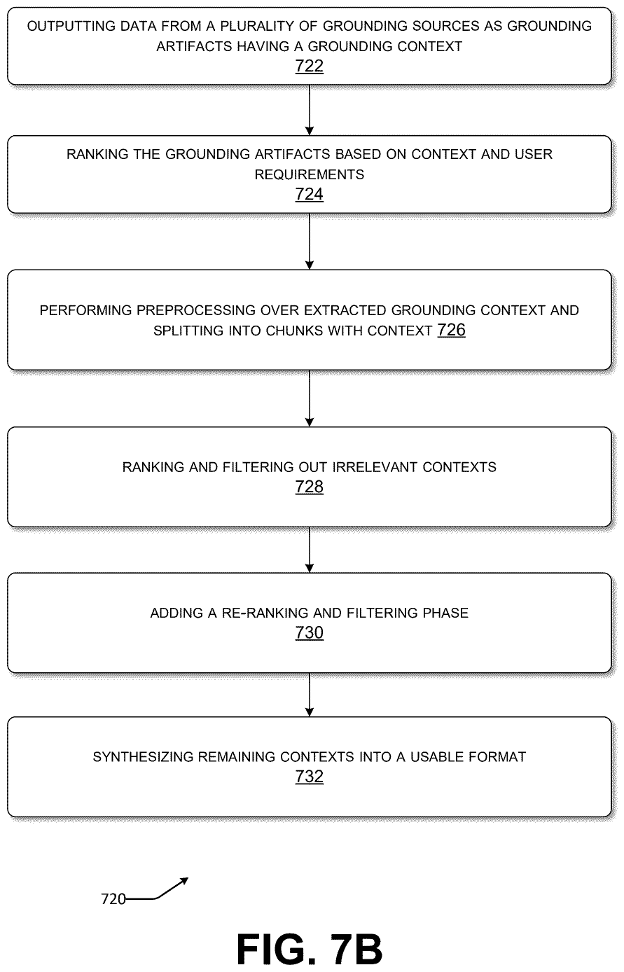

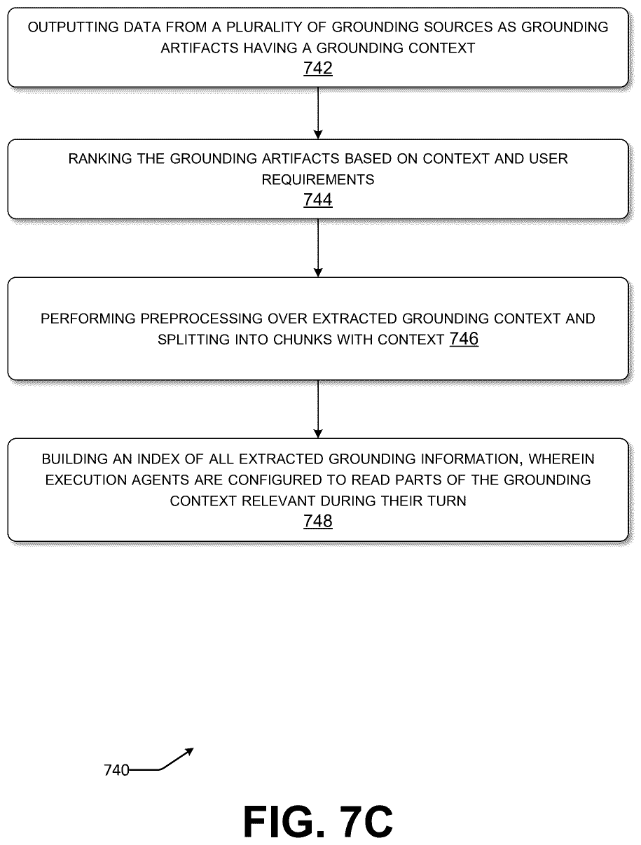

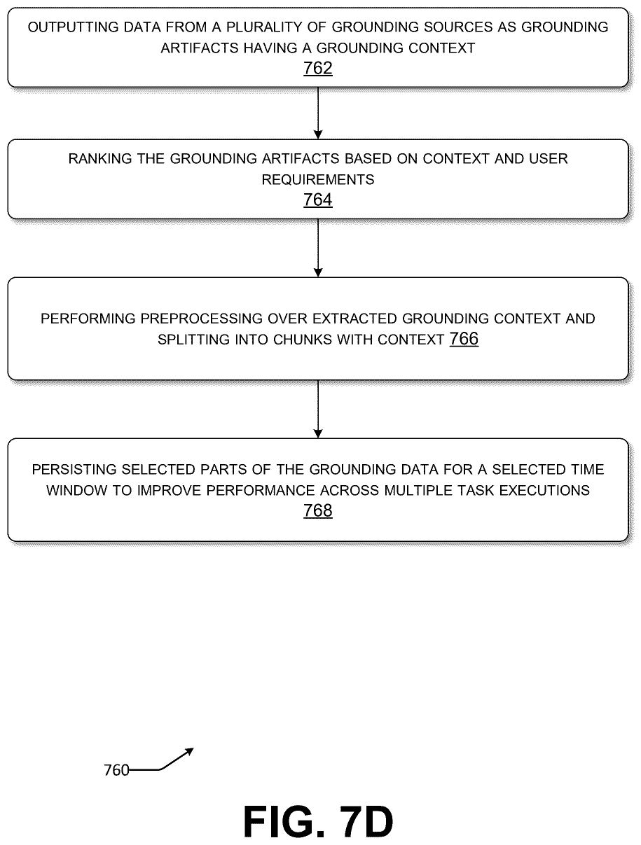

Turning to FIG. 7A, aspects of a process 700 for synthesizing information in a distributed computing and storage system. With respect to FIG. 7A, the process 700 includes operation 702 illustrating identifying data from a plurality of grounding sources in the distributed computing and storage system. In an embodiment, the data is identified in response to a request for grounding data from a service provider, AI model, AI agent, or other entity.

Operation 704 illustrates outputting the identified data as grounding artifacts of the form {grounding_context, context_metadata}. In an embodiment, the grounding context comprises a blob of text with information usable for grounding. In an embodiment, the context metadata includes information pertaining to what the blob of text represents, where the blob of text was extracted from, and in what context the information was shared.

Operation 706 illustrates ranking and refining the grounding artifacts based on context and user requirements.

Operation 708 illustrates that ranking comprises ranking the artifacts according to their relative importance and relevance.

Operation 710 illustrates that ranking comprises identifying dependencies, overlaps, and information conflicts.

Operation 712 illustrates that ranking comprises filtering out artifacts that do not connect with other relevant artifacts and are below a minimum relevance threshold. In an embodiment, the ranked and refined grounding artifacts are provided as output to a requesting service, application, or function, such as a service provider, AI model, AI agent, or other entity.

In addition to the above embodiments, enhancements and improvements can be implemented to improve the performance and efficiency of the described techniques. One shortcoming of conventional RAG techniques is that data is searched using similarity criteria, but such techniques do not associate a grounding context with relevancy to the task at hand. Traditional search techniques thus do not account for distinctions between relevance and similarity in a given context.

In one embodiment, improved preprocessing and reasoning with re-ranking can be implemented. Depending on the signals obtained based on the above described stages and with reference to FIGS. 6B and 6C, the processing pipeline is expanded to:
1. Perform preprocessing over extracted grounding context and split the data into chunks with context if needed. In an embodiment, the processing can be performed by preprocessing agent 611 which provides a list of grounding chunks to ranking agent 612.
2. Rank and filter out irrelevant contexts. Ranking can be performed by ranking agent 612 which computes relevancy scores and ranks the grounding chunks. A ranked list of grounding context chunks is provided to phase 613.
3. Add a re-ranking and filtering phase 613 to generate a list of grounding context chunks that are ranked and filtered 614. Re-ranking can be performed by re-ranking agent 621.
4. Synthesize remaining contexts into a usable format. Synthesizing can be performed by synthesizing agent 623.

Reasoning agent 615 receives the list of ranked and filtered grounding context chunks and generates a list of grounding context chunks with tagged relationships to the re-ranking agent 621. Re-ranking agent 621 updates relevancy scores while considering the tagged relationships. At stage 622, items with low relevancy scores and those conflicting with high relevancy items are dropped. The updated list of grounding context chunks with relationships tagged is provided to synthesizer agent 623.

In some embodiments, improvements can be implemented to the synthesis process with indexing. To improve the system's ability to manage large amounts of grounding context, an index is implemented of all extracted grounding information. Execution agents are configured to read parts of the grounding context relevant to their turn. The index allows for the reference to the source material to be retained so that the agents can refer to the report and obtain more information about a particular aspect.

FIGS. 6D and 6E illustrate an example of the improvements when added to the flows shown in FIGS. 6B and 6C. In other implementations, the improvements can be added on top of the core implementation as described herein. Referring to FIG. 6E, original summaries and dependent task notes from the meta grounding agent 645 are saved in grounding store 641. The saved information is indexed 642 as a grounding data index.

The reasoning agent 615 analyzes each topic and determines how the contexts relate with each other based on the ranking, thus allowing for more effective cross referencing of all the information sources. In some embodiments, a knowledge graph can be generated where chunks can be clustered by similarity and which reflects how each context is related to one another. The knowledge graph can be used to rank the chunks with greater insight than if the chunks were ranked without this information. For example, a given chunk may not otherwise indicate relevance, but may be determined to be relevant if the chunk supports another relevant context.

The execution workflow shown in FIG. 6A can be run for every task, which can consume significant resources. To more efficiently utilize the outputs of the disclosed techniques, the final results and intermediate results can be cached to enable reuse as needed. For example, the pre processing is not dependent on the specific task and is performed only on the source grounding context. The outputs of each stage, such as the grounding context chunks, ranked chunks, and filtered chunks can be cached in a persistent storage and available for other tasks in the same plan or that are using the same documents.

In some cases it is desired to re-run tasks and regenerate outputs. Thus it would be beneficial to cache, for example, reasoning results, so that multiple reasoning results are available for the same task and for the context of a single task execution.

In some embodiments, grounding is cached so that selected parts of the grounding data are persisted for a selected time window to improve performance across multiple task executions. Grounding data to be persisted can include:
Summary type responses from the meta grounding agent 645
Final ranked and filtered grounding contexts 614
Final synthesized response 646

Turning to FIG. 7B, aspects of a process 720 for synthesizing information in a distributed computing and storage system. With respect to FIG. 7B, the process 720 includes operation 722 illustrating outputting data from a plurality of grounding sources as grounding artifacts having a grounding context.

Operation 724 illustrates ranking the grounding artifacts based on context and user requirements.

Operation 726 illustrates performing preprocessing over extracted grounding context and splitting into chunks with context.

Operation 728 illustrates ranking and filtering out irrelevant contexts.

Operation 730 illustrates adding a re-ranking and filtering phase.

Operation 732 illustrates synthesizing remaining contexts into a usable format. In an embodiment, the contexts are provided as output to a requesting service, application, or function, such as a service provider, AI model, AI agent, or other entity.

Turning to FIG. 7C, aspects of a process 740 for synthesizing information in a distributed computing and storage system. With respect to FIG. 7C, the process 740 includes operation 742 illustrating outputting data from a plurality of grounding sources as grounding artifacts having a grounding context.

Operation 744 illustrates ranking the grounding artifacts based on context and user requirements.

Operation 746 illustrates performing preprocessing over extracted grounding context and splitting into chunks with context.

Operation 748 illustrates building an index of all extracted grounding information. In an embodiment, execution agents are configured to read parts of the grounding context relevant during their turn. In an embodiment, the indexed grounding information is provided as output to a requesting service, application, or function, such as a service provider, AI model, AI agent, or other entity.

Turning to FIG. 7D, aspects of a process 760 for synthesizing information in a distributed computing and storage system. With respect to FIG. 7D, the process 760 includes operation 762 illustrating outputting data from a plurality of grounding sources as grounding artifacts having a grounding context.

Operation 764 illustrates ranking the grounding artifacts based on context and user requirements.

Operation 766 illustrates performing preprocessing over extracted grounding context and splitting into chunks with context.

Operation 768 illustrates persisting selected parts of the grounding data for a selected time window to improve performance across multiple task executions. In an embodiment, the ground data to be persisted comprises:
summary type responses from the meta grounding agent;
final ranked and filtered grounding contexts; and
final synthesized response.

In an embodiment, the persisted parts of the grounding data are provided as output to a requesting service, application, or function, such as a service provider, AI model, AI agent, or other entity.

For ease of understanding, the process discussed in this disclosure is delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 700 can be implemented, at least in part, by modules running the features disclosed herein which can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 700 may also be implemented in other ways. In addition, one or more of the operations of the process 700 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

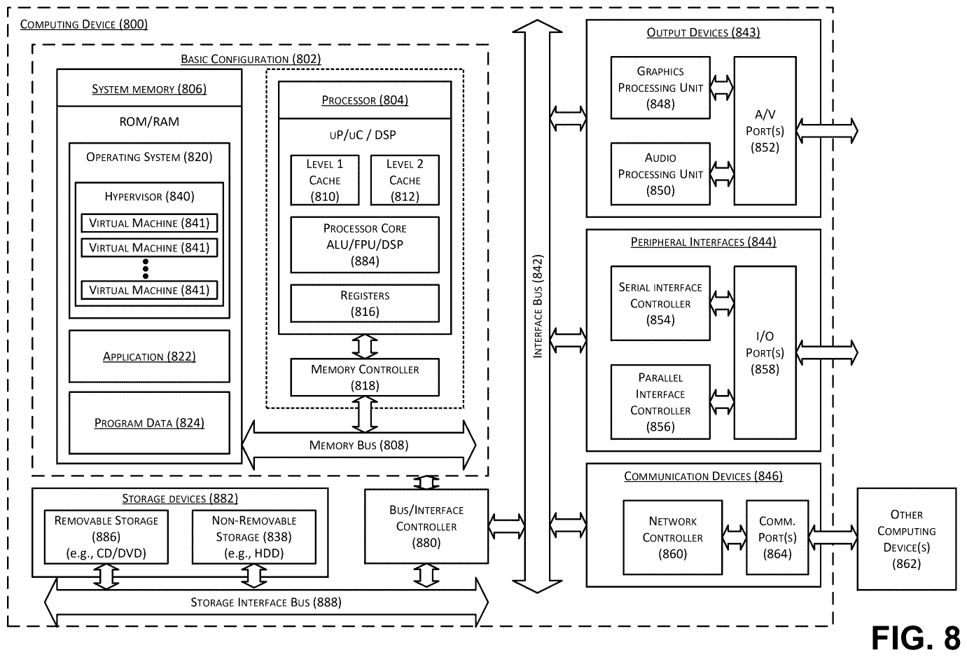

FIG. 8 is a computing device 800 suitable for certain components of a computing system device or system. In a very basic configuration 802, the computing device 800 can include one or more processors 804 and a system memory 806. A memory bus 808 can be used for communicating between processor 804 and system memory 806. Depending on the desired configuration, the processor 804 can be of any type including but not limited to a microprocessor (μP), a microcontroller (μC), a digital signal processor (DSP), or any combination thereof. The processor 804 can include one more levels of caching, such as a level-one cache 810 and a level-two cache 812, a processor core 884, and registers 816. An example processor core 884 can include an arithmetic logic unit (ALU), a floating point unit (FPU), a digital signal processing core (DSP Core), or any combination thereof. An example memory controller 818 can also be used with processor 804, or in some implementations memory controller 818 can be an internal part of processor 804.

Depending on the desired configuration, the system memory 806 can be of any type including but not limited to volatile memory (such as RAM), non-volatile memory (such as ROM, flash memory, etc.) or any combination thereof. The system memory 806 can include an operating system 820, one or more applications 822, and program data 824. As shown in FIG. 8, the operating system 820 can include a hypervisor 840 for managing one or more virtual machines 841. This described basic configuration 802 is illustrated in FIG. 8 by those components within the inner dashed line.

The computing device 800 can have additional features or functionality, and additional interfaces to facilitate communications between basic configuration 802 and any other devices and interfaces. For example, a bus/interface controller 880 can be used to facilitate communications between the basic configuration 802 and one or more data storage devices 882 via a storage interface bus 888. The data storage devices 882 can be removable storage devices 886, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 806, removable storage devices 886, and non-removable storage devices 838 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 800. Any such computer readable storage media can be a part of computing device 800. The term “computer readable storage medium” excludes propagated signals and communication media.

The computing device 800 can also include an interface bus 842 for facilitating communication from various interface devices (e.g., output devices 843, peripheral interfaces 844, and communication devices 846) to the basic configuration 802 via bus/interface controller 880. Example output devices 843 include a graphics processing unit 848 and an audio processing unit 850, which can be configured to communicate to various external devices such as a display or speakers via one or more A/V ports 852. Example peripheral interfaces 844 include a serial interface controller 854 or a parallel interface controller 856, which can be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which can be arranged to facilitate communications with one or more other computing devices 862 over a network communication link via one or more communication ports 864.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 800 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 800 can also be implemented as a personal computer including both laptop computer and non-laptop computer configurations.

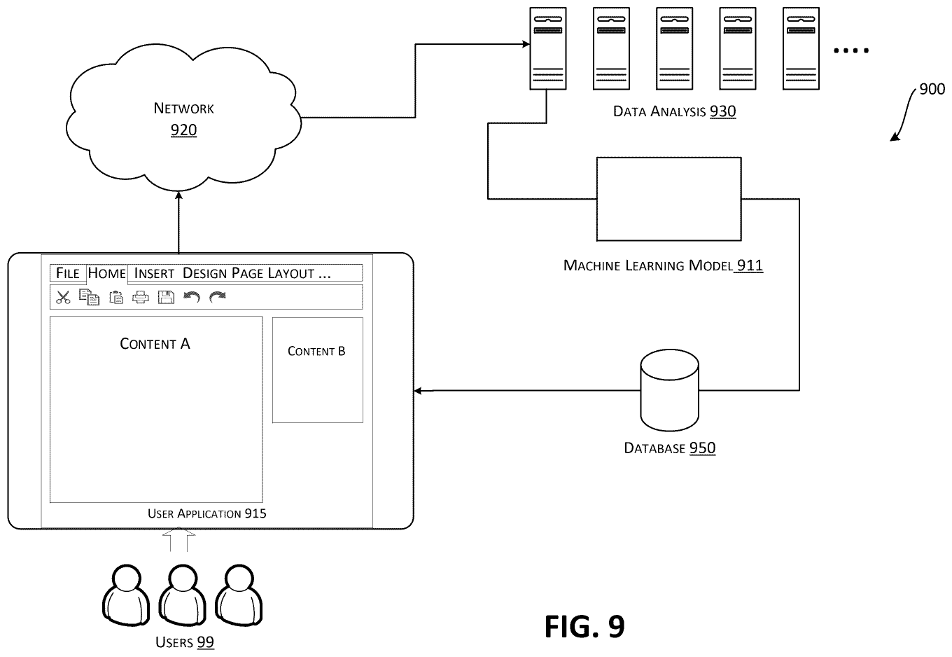

FIG. 9 is a computing system architecture diagram showing an overview of a system disclosed herein for implementing a machine learning model, according to one embodiment disclosed herein. As shown in FIG. 9, a machine learning system 900 may be configured to perform analysis and perform identification, prediction, or other functions based upon various data collected by and processed by data analysis components 930 (which might be referred to individually as an “data analysis component 930” or collectively as the “data analysis components 930”). The data analysis components 930 may, for example, include, but are not limited to, physical computing devices such as server computers or other types of hosts, associated hardware components (e.g., memory and mass storage devices), and networking components (e.g., routers, switches, and cables). The data analysis components 930 can also include software, such as operating systems, applications, and containers, network services, virtual components, such as virtual disks, virtual networks, and virtual machines. Database 950 can include data, such as a database, or a database shard (i.e., a partition of a database). Feedback may be used to further update various parameters that are used by machine learning model 920. Data may be provided to the user application 915 to provide results to various users 99 using a user application 915. In some configurations, machine learning model 911 may be configured to utilize supervised and/or unsupervised machine learning technologies. A model compression framework based on sparsity-inducing regularization optimization as disclosed herein can reduce the amount of data that needs to be processed in such systems and applications. Effective model compression when processing iterations over large amounts of data may provide improved latencies for a number of applications that use such technologies, such as image and sound recognition, recommendation systems, and image analysis.

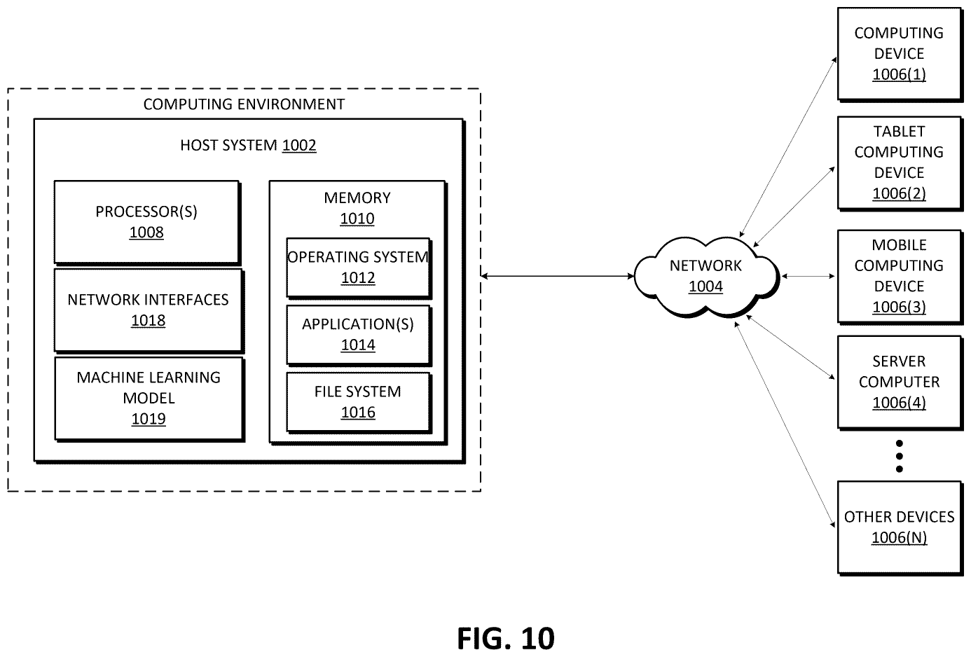

FIG. 10 illustrates an example computing environment capable of executing the techniques and processes described above with respect to FIGS. 1-8. In various examples, the computing environment comprises a host system 1002. In various examples, the host system 1002 operates on, in communication with, or as part of a network 1004.

The network 1004 can be or can include various access networks. For example, one or more client devices 1006(1) . . . 1006(N) can communicate with the host system 1002 via the network 1004 and/or other connections. The host system 1002 and/or client devices can include, but are not limited to, any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 1002 can be provided by one or more servers that are executing as part of, or in communication with, the network 1004. A server can host various services, virtual machines, portals, and/or other resources. For example, a can host or provide access to one or more portals, Web sites, and/or other information.

The host system 1002 can include processor(s) 1008 memory 1010. The memory 1010 can comprise an operating system 1012, application(s) 1014, and/or a file system 1016.

The processor(s) 1008 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 1010.

The memory 1010 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 1002 can communicate over the network 1004 via network interfaces 1018. The network interfaces 1018 can include various types of network hardware and software for supporting communications between two or more devices. The host system 1002 may also include machine learning model 1019.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for synthesizing information in a distributed computing and storage system, the method comprising:
identifying data from a plurality of grounding sources in the distributed computing and storage system;
outputting the identified data as grounding artifacts of the form (grounding context, context metadata), wherein the grounding context comprises a blob of text with information usable for grounding, and wherein the context metadata includes information pertaining to what the blob of text represents, where the blob of text was extracted from, and in what context the information was shared; and
ranking and refining the grounding artifacts based on context and user requirements, wherein the ranking comprises:
ranking the artifacts according to their relative importance and relevance;
identifying dependencies, overlaps, and information conflicts; and
filtering out artifacts that do not connect with other relevant artifacts and are below a minimum relevance threshold.

Clause 2: The method of clause 1, wherein the identifying data is performed by a meta grounding agent.

Clause 3: The method of any of clauses 1-2, wherein the ranking and refining is performed by a grounding context synthesizer.

Clause 4: The method of any of clauses 1-3, further comprising using a preprocessor agent to split long contexts into smaller chunks.

Clause 5: The method of any of clauses 1-4, further comprising using a reasoning agent to cluster preprocessed contexts per topic and assess which grounding contexts are less relevant.

Clause 6: The method of any of clauses 1-5, further comprising using a reasoning agent to collect results and join into one cohesive grounding context string.

Clause 7: The method of clauses 1-6, further comprising using a questioning agent to generate questions to obtain missing information needed to complete tasks.

Clause 8: A system for synthesizing information in a distributed computing and storage network, the system comprising:
a processor; and
a computer-readable storage medium having encoded thereon computer-readable instructions that when executed by the processor, cause the system to perform operations comprising:
identifying data from a plurality of grounding sources in the distributed computing and storage network;
outputting the identified data as grounding artifacts of the form {grounding_context, context_metadata}, wherein the grounding context comprises a blob of text with information usable for grounding, and wherein the context metadata includes information pertaining to what the blob of text represents, where the blob of text was extracted from, and in what context the information was shared; and
ranking and refining the grounding artifacts based on context and user requirements, wherein the ranking comprises:
   ranking the artifacts according to their relative importance and relevance;
   identifying dependencies, overlaps, and information conflicts; and
filtering out artifacts that do not connect with other relevant artifacts and are below a minimum relevance threshold.

Clause 9: The system of clause 8, wherein the identifying data is performed by a meta grounding agent.

Clause 10: The system of any of clauses 8 and 9, wherein the ranking and refining is performed by a grounding context synthesizer.

Clause 11: The system of any of clauses 8-10, further comprising computer-readable instructions that when executed by the processor, cause the system to perform operations comprising using a preprocessor agent to split long contexts into smaller chunks.

Clause 12: The system of any of clauses 8-11, further comprising computer-readable instructions that when executed by the processor, cause the system to perform operations comprising using a reasoning agent to cluster preprocessed contexts per topic and assess which grounding contexts are less relevant.

Clause 13: The system of any of clauses 8-12, further comprising computer-readable instructions that when executed by the processor, cause the system to perform operations comprising using a reasoning agent to collect results and join into one cohesive grounding context string.

Clause 14: The system of any of clauses 8-13, further comprising computer-readable instructions that when executed by the processor, cause the system to perform operations comprising using a questioning agent to generate questions to obtain missing information needed to complete tasks.

Clause 15: A computer-readable storage medium having encoded thereon computer-readable instructions that when executed by a system, cause the system to perform operations comprising:
identifying data from a plurality of grounding sources in a distributed computing and storage system;
outputting the identified data as grounding artifacts of the form {grounding_context, context_metadata}, wherein the grounding context comprises a blob of text with information usable for grounding, and wherein the context metadata includes information pertaining to what the blob of text represents, where the blob of text was extracted from, and in what context the information was shared; and
ranking and refining the grounding artifacts based on context and user requirements, wherein the ranking comprises:
ranking the artifacts according to their relative importance and relevance;
identifying dependencies, overlaps, and information conflicts; and
filtering out artifacts that do not connect with other relevant artifacts and are below a minimum relevance threshold.

Clause 16: The computer-readable storage medium of clause 15, wherein the identifying data is performed by a meta grounding agent.

Clause 17: The computer-readable storage medium of any of clauses 15 and 16, wherein the ranking and refining is performed by a grounding context synthesizer.

Clause 18: The computer-readable storage medium of any of clauses 15-17, further comprising computer-readable instructions that when executed by a system, cause the system to perform operations comprising using a preprocessor agent to split long contexts into smaller chunks.

Clause 19: The computer-readable storage medium of any of clauses 15-18, further comprising computer-readable instructions that when executed by a system, cause the system to perform operations comprising using a reasoning agent to cluster preprocessed contexts per topic and assess which grounding contexts are less relevant.

Clause 20: The computer-readable storage medium of any of the clauses 15-19, further comprising computer-readable instructions that when executed by a system, cause the system to perform operations comprising using a reasoning agent to collect results and join into one cohesive grounding context string.

The disclosure presented herein also encompasses the subject matter set forth in the following additional clauses:

Clause 1: A method for synthesizing information in a distributed computing and storage system, the method comprising:
outputting data from a plurality of grounding sources as grounding artifacts having a grounding context;
ranking the grounding artifacts based on context and user requirements;
performing preprocessing over extracted grounding context and splitting into chunks with context;
ranking and filtering out irrelevant contexts;
adding a re-ranking and filtering phase; and
synthesizing remaining contexts into a usable format.

Clause 2: The method of clause 1, wherein the identifying data is performed by a meta grounding agent.

Clause 3: The method of any of clauses 1-2, wherein the ranking and refining is performed by a grounding context synthesizer.

Clause 4: The method of any of clauses 1-3, further comprising using a preprocessor agent to split long contexts into smaller chunks.

Clause 5: The method of any of clauses 1-4, further comprising using a reasoning agent to cluster preprocessed contexts per topic and assess which grounding contexts are less relevant.

Clause 6: The method of any of clauses 1-5, further comprising using a reasoning agent to collect results and join into one cohesive grounding context string.

Clause 7: The method of clauses 1-6, further comprising using a questioning agent to generate questions to obtain missing information needed to complete tasks.

Clause 8: A system for synthesizing information in a distributed computing and storage network, the system comprising:
a processor; and
a computer-readable storage medium having encoded thereon computer-readable instructions that when executed by the processor, cause the system to perform operations comprising:
outputting data from a plurality of grounding sources as grounding artifacts having a grounding context;
ranking the grounding artifacts based on context and user requirements; performing preprocessing over extracted grounding context and splitting into chunks with context; and
building an index of all extracted grounding information, wherein execution agents are configured to read parts of the grounding context relevant during their turn.

Clause 9: The system of clause 8, wherein the identifying data is performed by a meta grounding agent.

Clause 10: The system of any of clauses 8 and 9, wherein the ranking and refining is performed by a grounding context synthesizer.

Clause 11: The system of any of clauses 8-10, further comprising computer-readable instructions that when executed by the processor, cause the system to perform operations comprising using a preprocessor agent to split long contexts into smaller chunks.

Clause 12: The system of any of clauses 8-11, further comprising computer-readable instructions that when executed by the processor, cause the system to perform operations comprising using a reasoning agent to cluster preprocessed contexts per topic and assess which grounding contexts are less relevant.

Clause 13: The system of any of clauses 8-12, further comprising computer-readable instructions that when executed by the processor, cause the system to perform operations comprising using a reasoning agent to collect results and join into one cohesive grounding context string.

Clause 14: The system of any of clauses 8-13, further comprising computer-readable instructions that when executed by the processor, cause the system to perform operations comprising using a questioning agent to generate questions to obtain missing information needed to complete tasks.

Clause 15: The system of any of clauses 8-14, further comprising computer-readable instructions that when executed by the processor, cause the system to perform operations comprising generating a knowledge graph comprising chunks that are clustered by similarity and is indicative of how each context is related to one another.

Clause 16: A computer-readable storage medium having encoded thereon computer-readable instructions that when executed by a system, cause the system to perform operations comprising:
outputting data from a plurality of grounding sources as grounding artifacts having a grounding context;
ranking the grounding artifacts based on context and user requirements;
performing preprocessing over extracted grounding context and splitting into chunks with context; and
persisting selected parts of the grounding data for a selected time window to improve performance across multiple task executions, wherein the ground data to be persisted comprises:
summary type responses from the meta grounding agent;
final ranked and filtered grounding contexts; and
final synthesized response.

Clause 17: The computer-readable storage medium of clause 16, wherein the identifying data is performed by a meta grounding agent.

Clause 18: The computer-readable storage medium of any of clauses 16 and 17, wherein the ranking and refining is performed by a grounding context synthesizer.

Clause 19: The computer-readable storage medium of any of clauses 16-18, further comprising computer-readable instructions that when executed by a system, cause the system to perform operations comprising using a preprocessor agent to split long contexts into smaller chunks.

Clause 20: The computer-readable storage medium of any of clauses 16-19, further comprising computer-readable instructions that when executed by a system, cause the system to perform operations comprising using a reasoning agent to cluster preprocessed contexts per topic and assess which grounding contexts are less relevant.

1. A method for synthesizing information in a distributed computing and storage system, the method comprising:
outputting data from a plurality of grounding sources as grounding artifacts having a grounding context;
ranking the grounding artifacts based on context and user requirements;
performing preprocessing over extracted grounding context and splitting into chunks with context;
ranking and filtering out irrelevant contexts;
adding a re-ranking and filtering phase; and
synthesizing remaining contexts into a usable format.

2. The method of claim 1, wherein the data is identified by a meta grounding agent.

3. The method of claim 1, wherein the ranking is performed by a grounding context synthesizer.

4. The method of claim 1, further comprising using a preprocessor agent to split long contexts into smaller chunks.

5. The method of claim 1, further comprising using a reasoning agent to cluster preprocessed contexts per topic and assess which grounding contexts are less relevant.

6. The method of claim 1, further comprising using a reasoning agent to collect results and join into one cohesive grounding context string.

7. The method of claim 1, further comprising using a questioning agent to generate questions to obtain missing information needed to complete tasks.

8. A system for synthesizing information in a distributed computing and storage network, the system comprising:
a processor; and
a computer-readable storage medium having encoded thereon computer-readable instructions that when executed by the processor, cause the system to perform operations comprising:
outputting data from a plurality of grounding sources as grounding artifacts having a grounding context;
ranking the grounding artifacts based on context and user requirements;
performing preprocessing over extracted grounding context and splitting into chunks with context; and
building an index of all extracted grounding information, wherein execution agents are configured to read parts of the grounding context relevant during their turn.

9. The system of claim 8, wherein the data is identified by a meta grounding agent.

10. The system of claim 8, wherein the ranking and refining is performed by a grounding context synthesizer.

11. The system of claim 8, further comprising computer-readable instructions that when executed by the processor, cause the system to perform operations comprising using a preprocessor agent to split long contexts into smaller chunks.

12. The system of claim 8, further comprising computer-readable instructions that when executed by the processor, cause the system to perform operations comprising using a reasoning agent to cluster preprocessed contexts per topic and assess which grounding contexts are less relevant.

13. The system of claim 8, further comprising computer-readable instructions that when executed by the processor, cause the system to perform operations comprising using a reasoning agent to collect results and join into one cohesive grounding context string.

14. The system of claim 8, further comprising computer-readable instructions that when executed by the processor, cause the system to perform operations comprising using a questioning agent to generate questions to obtain missing information needed to complete tasks.

15. The system of claim 8, further comprising computer-readable instructions that when executed by the processor, cause the system to perform operations comprising generating a knowledge graph comprising chunks that are clustered by similarity and is indicative of how each context is related to one another.

16. A computer-readable storage medium having encoded thereon computer-readable instructions that when executed by a system, cause the system to perform operations comprising:
outputting data from a plurality of grounding sources as grounding artifacts having a grounding context;
ranking the grounding artifacts based on context and user requirements;
performing preprocessing over extracted grounding context and splitting into chunks with context; and
persisting selected parts of the grounding data for a selected time window to improve performance across multiple task executions, wherein the ground data to be persisted comprises:
summary type responses from the meta grounding agent;
final ranked and filtered grounding contexts; and
final synthesized response.

17. The computer-readable storage medium of claim 16, wherein the data is identified by a meta grounding agent.

18. The computer-readable storage medium of claim 16, wherein the ranking and refining is performed by a grounding context synthesizer.

19. The computer-readable storage medium of claim 18, further comprising computer-readable instructions that when executed by a system, cause the system to perform operations comprising using a preprocessor agent to split long contexts into smaller chunks.

20. The computer-readable storage medium of claim 16, further comprising computer-readable instructions that when executed by a system, cause the system to perform operations comprising using a reasoning agent to cluster preprocessed contexts per topic and assess which grounding contexts are less relevant.
